(19) United States
(12) Patent Application Publication
(10) Pub. No.: US 2025/0317985 A1
(43) Pub. Date: Oct. 9, 2025

(54) RANDOM ACCESS CHANNEL (RACH) PREAMBLE REPETITION FOR SUBBAND NON-OVERLAPPING FULL DUPLEX (SBFD) OPERATION

(71) Applicant: QUALCOMM Incorporated, San Diego, CA (US)

(72) Inventors: Muhammad Sayed Khairy ABDELGHAFFAR, San Jose, CA (US); Ahmed Attia ABOTABL, San Diego, CA (US); Hung Dinh LY, San Diego, CA (US); Gokul SRIDHARAN, Sunnyvale, CA (US); Abdelrahman Mohamed IBRAHIM, San Diego, CA (US)

(21) Appl. No.: 19/072,739

(22) Filed: Mar. 6, 2025

Related U.S. Application Data
(60) Provisional application No. 63/575,088, filed on Apr. 5, 2024.

(51) Int. Cl. H04W 74/0833; H04L 5/14; H04W 74/00

(52) U.S. Cl. CPC H04W 74/0833; H04L 5/14; H04W 74/002

(57) ABSTRACT

Methods, systems, and devices for wireless communication are described. In some systems, a network entity may receive configuration information for a physical random access channel (PRACH) transmission. The configuration information may indicate a random access channel (RACH) occasion (RO) group and a quantity of preamble repetitions, where the RO group includes a set of valid PRACH occasions. In some aspects, the network entity may support subband non-overlapping full duplex (SBFD) operation, and the set of valid PRACH occasions may include at least one SBFD RO that is valid for PRACH transmission. The RO group may support a single duplex symbol type (e.g., SBFD symbols) or may support different duplex symbol types (e.g., a combination of SBFD and non-SBFD symbols). The network entity may transmit multiple instances of a PRACH message via the RO group, where the quantity of PRACH message instances is equal to the quantity of preamble repetitions.

### CROSS REFERENCE

The present Application for Patent claims the benefit of U.S. Provisional Patent Application No. 63/575,088 by ABDELGHAFFAR et al., entitled “RANDOM ACCESS CHANNEL (RACH) PREAMBLE REPETITION FOR SUBBAND NON-OVERLAPPING FULL DUPLEX (SBFD) OPERATION,” filed Apr. 5, 2024, and assigned to the assignee hereof. U.S. Provisional Patent Application No. 63/575,088 is expressly incorporated by reference herein in its entirety.

### INTRODUCTION

The following relates to wireless communication that pertain to random access channel (RACH) procedures.

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support random access channel (RACH) preamble repetition for subband non-overlapping full duplex (SBFD) operation. For example, the described techniques provide for improved reliability and resource utilization associated with random access procedures. In some wireless communication systems, a network entity, such as a user equipment (UE), may receive configuration information for a physical random access channel (PRACH) transmission. The configuration information may indicate a RACH occasion (RO) group and a quantity of preamble repetitions for the PRACH transmission, where the RO group includes a set of valid PRACH occasions. In some aspects, the network entity may support SBFD operation, and the set of valid PRACH occasions may include at least one SBFD RO that is valid for PRACH transmission. The SBFD RO may be an example of an RO within an uplink subband of an SBFD symbol. In some aspects, the RO group may support a single duplex symbol type (e.g., with ROs in SBFD symbols). In some other aspects, the RO group may support different duplex symbol types (e.g., with ROs in a combination of SBFD and non-SBFD symbols). Additionally, or alternatively, the configuration information may include a single RACH configuration or multiple RACH configurations. The network entity may receive the configuration information and may transmit multiple instances of a PRACH message based on the configuration information. For example, the network entity may transmit, via the RO group including at least one SBFD RO, the multiple instances of the PRACH message, where the quantity of transmitted PRACH message instances may be equal to the configured quantity of preamble repetitions.

A method of wireless communication performed by a network entity is described. The method may include receiving configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The method may further include transmitting, via the RO group, a set of multiple instances of a PRACH message based on the quantity of preamble repetitions.

A network entity for wireless communication is described. The network entity may include a processing system configured to receive configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The processing system may be configured to transmit, via the RO group, a set of multiple instances of a PRACH message based on the quantity of preamble repetitions.

Another network entity for wireless communication is described. The network entity may include means for receiving configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The network entity may further include means for transmitting, via the RO group, a set of multiple instances of a PRACH message based on the quantity of preamble repetitions.

A non-transitory computer-readable medium having code for wireless communication stored thereon is described. The code, when executed by a network entity, may cause the network entity to receive configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The code, when executed by the network entity, may further cause the network entity to transmit, via the RO group, a set of multiple instances of a PRACH message based on the quantity of preamble repetitions.

In some aspects of the method, network entities, and non-transitory computer-readable medium described herein, the RO group may be a first RO group, where the first RO group includes SBFD ROs, and the configuration information further indicates a second RO group, where the second RO group includes time division duplex (TDD) ROs. In some aspects of the method, network entities, and non-transitory computer-readable medium described herein, the configuration information may separately indicate: a first PRACH sequence format, a first transmit beam, a first set of frequency resources, a first RACH preamble, or any combination thereof that correspond to the first RO group; and a second PRACH sequence format different from the first PRACH sequence format, a second transmit beam different from the first transmit beam, a second set of frequency resources different from the first set of frequency resources, a second RACH preamble different from the first RACH preamble, or any combination thereof that correspond to the second RO group. In some aspects of the method, network entities, and non-transitory computer-readable medium described herein, the quantity of preamble repetitions may be a first quantity of preamble repetitions for the SBFD ROs and the configuration information separately indicates a second quantity of preamble repetitions for the TDD ROs.

In some aspects of the method, network entities, and non-transitory computer-readable medium described herein, the configuration information indicates, for the first RO group and the second RO group, a same PRACH sequence format, a same transmit beam, a same set of frequency resources, a same RACH preamble, or any combination thereof. In some aspects of the method, network entities, and non-transitory computer-readable medium described herein, the quantity of preamble repetitions corresponds to both the first RO group and the second RO group.

In some aspects of the method, network entities, and non-transitory computer-readable medium described herein, the RO group includes the at least one SBFD RO and at least one TDD RO.

Some aspects of the method, network entities, and non-transitory computer-readable medium described herein may include operations, features, means, or code for receiving information that indicates the RO group supports a same duplex symbol type. Some other aspects of the method, network entities, and non-transitory computer-readable medium described herein may include operations, features, means, or code for receiving information that indicates the RO group supports different duplex symbol types.

Some aspects of the method, network entities, and non-transitory computer-readable medium described herein may include operations, features, means, or code for determining, based on a comparison of PRACH parameters configured for SBFD symbols and for non-SBFD symbols, that the RO group supports a same duplex symbol type or different duplex symbol types. In some aspects of the method, network entities, and non-transitory computer-readable medium described herein, the PRACH parameters include a PRACH sequence format, a transmit beam, a set of frequency resources, a RACH preamble, or any combination thereof.

In some aspects of the method, network entities, and non-transitory computer-readable medium described herein, the quantity of preamble repetitions may be a first quantity of preamble repetitions for the network entity that supports the at least one SBFD RO as valid for the PRACH transmission and the configuration information further indicates a second quantity of preamble repetitions for a second network entity that fails to recognize SBFD ROs as valid for the PRACH transmission.

In some aspects of the method, network entities, and non-transitory computer-readable medium described herein, the RO group for the network entity shares one or more ROs with a second RO group for the second network entity and the RO group and the second RO group correspond to different RACH preambles for the one or more shared ROs. In some other aspects of the method, network entities, and non-transitory computer-readable medium described herein, first respective ROs of the RO group for the network entity may be distinct from second respective ROs of a second RO group for the second network entity.

Some aspects of the method, network entities, and non-transitory computer-readable medium described herein may include operations, features, means, or code for receiving a random access response (RAR) message based on at least one instance of the set of multiple instances of the PRACH message. In some aspects of the method, network entities, and non-transitory computer-readable medium described herein, the set of multiple instances of the PRACH message corresponds to a single RAR and the method, apparatuses, and non-transitory computer-readable medium may include operations, features, means, or code for monitoring for the RAR message via a monitoring occasion associated with the single RAR.

In some aspects of the method, network entities, and non-transitory computer-readable medium described herein, the at least one SBFD RO may be within a subband configured for uplink transmission within an SBFD symbol.

In some aspects of the method, network entities, and non-transitory computer-readable medium described herein, the set of valid PRACH occasions includes a set of multiple PRACH occasions that span a same set of frequency resources, correspond to a same transmit beam, correspond to a same transmit power, correspond to a same RACH preamble, or correspond to a same duplex symbol type.

In some aspects of the method, network entities, and non-transitory computer-readable medium described herein, the configuration information includes a radio resource control (RRC) signal or a system information block (SIB).

In some aspects of the method, network entities, and non-transitory computer-readable medium described herein, a quantity of the set of multiple instances of the PRACH message may be equal to the quantity of preamble repetitions. In some aspects of the method, network entities, and non-transitory computer-readable medium described herein, the quantity of preamble repetitions may be greater than one. In some aspects of the method, network entities, and non-transitory computer-readable medium described herein, a quantity of occasions of the set of valid PRACH occasions may be equal to the quantity of preamble repetitions.

A method of wireless communication performed by a network entity is described. The method may include causing transmission of configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The method may further include receiving, via the RO group, at least one instance of a set of multiple instances of a PRACH message based on the quantity of preamble repetitions.

A network entity for wireless communication is described. The network entity may include a processing system configured to cause transmission of configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The processing system may be configured to receive, via the RO group, at least one instance of a set of multiple instances of a PRACH message based on the quantity of preamble repetitions.

Another network entity for wireless communication is described. The network entity may include means for causing transmission of configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The network entity may further include means for receiving, via the RO group, at least one instance of a set of multiple instances of a PRACH message based on the quantity of preamble repetitions.

A non-transitory computer-readable medium having code for wireless communication stored thereon is described. The code, when executed by a network entity, may cause the network entity to cause transmission of configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The code, when executed by the network entity, may further cause the network entity to receive, via the RO group, at least one instance of a set of multiple instances of a PRACH message based on the quantity of preamble repetitions.

In some aspects of the method, network entities, and non-transitory computer-readable medium described herein, the RO group may be a first RO group, where the first RO group includes SBFD ROs, and the configuration information further indicates a second RO group, where the second RO group includes TDD ROs.

In some aspects of the method, network entities, and non-transitory computer-readable medium described herein, the configuration information separately indicates: a first PRACH sequence format, a first transmit beam, a first set of frequency resources, a first RACH preamble, or any combination thereof that correspond to the first RO group; and a second PRACH sequence format different from the first PRACH sequence format, a second transmit beam different from the first transmit beam, a second set of frequency resources different from the first set of frequency resources, a second RACH preamble different from the first RACH preamble, or any combination thereof that correspond to the second RO group.

In some aspects of the method, network entities, and non-transitory computer-readable medium described herein, the quantity of preamble repetitions is a first quantity of preamble repetitions for the SBFD ROs, and the configuration information separately indicates a second quantity of preamble repetitions for the TDD ROs. In some aspects of the method, network entities, and non-transitory computer-readable medium described herein, the configuration information indicates, for the first RO group and the second RO group, a same PRACH sequence format, a same transmit beam, a same set of frequency resources, a same RACH preamble, or any combination thereof. In some aspects of the method, network entities, and non-transitory computer-readable medium described herein, the quantity of preamble repetitions corresponds to both the first RO group and the second RO group.

In some aspects of the method, network entities, and non-transitory computer-readable medium described herein, the configuration information includes an RRC signal or a SIB.

### BRIEF DESCRIPTION OF THE DRAWINGS

FIGS. 1 and 2 show examples of wireless communication systems that support random access channel (RACH) preamble repetition for subband non-overlapping full duplex (SBFD) operation in accordance with one or more aspects of the present disclosure.

FIGS. 3 through 5 show examples of RACH configurations that support RACH preamble repetition for SBFD operation in accordance with one or more aspects of the present disclosure.

FIG. 6 shows an example of a process flow that supports RACH preamble repetition for SBFD operation in accordance with one or more aspects of the present disclosure.

FIGS. 7 and 8 show block diagrams of devices that support RACH preamble repetition for SBFD operation in accordance with one or more aspects of the present disclosure.

FIG. 9 shows a block diagram of a communications manager that supports RACH preamble repetition for SBFD operation in accordance with one or more aspects of the present disclosure.

FIG. 10 shows a diagram of a system including a device that supports RACH preamble repetition for SBFD operation in accordance with one or more aspects of the present disclosure.

FIGS. 11 through 14 show flowcharts illustrating methods that support RACH preamble repetition for SBFD operation in accordance with one or more aspects of the present disclosure.

### DETAILED DESCRIPTION

In some wireless communication systems, a network entity, such as a user equipment (UE), may support subband non-overlapping full duplex (SBFD) operation. In SBFD operation, the network entity may determine a symbol configured for SBFD communications (e.g., an SBFD symbol) and may transmit uplink signaling via a subband configured for uplink communications of the SBFD symbol. Other frequency resources of the SBFD symbol may support downlink communications, such that the frequency resources of the SBFD symbol configured for uplink are “non-overlapping” in the frequency domain with the frequency resources of the SBFD symbol configured for downlink. In some aspects, a wireless communication system may include a first subset of network entities (e.g., “SBFD-aware” UEs) that support SBFD operation and may include a second subset of network entities (e.g., “non-SBFD-aware” or “legacy” UEs) that function according to time division duplex (TDD) operation. For example, in TDD operation, a network entity may transmit uplink signaling via a symbol configured for uplink operations and may receive downlink signaling via a symbol configured for downlink operations, but the network entity may not recognize an SBFD symbol. The wireless communication system may use SBFD symbols to improve random access procedures for network entities that support SBFD operations.

For example, a network entity that supports SBFD operation may receive configuration information for a physical random access channel (PRACH) transmission. In some aspects, the network entity (e.g., a UE) may receive the configuration information via a radio resource control (RRC) message or a broadcast signal from another network entity (e.g., a base station or other network entity). The configuration information may indicate a RACH occasion (RO) group and a quantity of preamble repetitions for the PRACH transmission, where the RO group includes a set of valid PRACH occasions. In some aspects, the set of valid PRACH occasions may include at least one SBFD RO that is valid for PRACH transmission. An SBFD RO may be an example of an RO within an uplink subband of an SBFD symbol. In some aspects, the RO group may support a single duplex symbol type (e.g., cither ROs in SBFD symbols or ROs in non-SBFD symbols, such as TDD symbols). In some other aspects, the RO group may support different duplex symbol types (e.g., ROs in a combination of SBFD and non-SBFD symbols). Additionally, or alternatively, the configuration information may include a single RACH configuration or multiple RACH configurations. For example, the single RACH configuration may indicate different information (e.g., different ROs, different quantities of preamble repetitions) to SBFD-aware UEs as compared to non-SBFD-aware UEs. Alternatively, the multiple RACH configurations may include a first RACH configuration indicating information to SBFD-aware UEs and a second RACH configuration indicating different information to non-SBFD-aware UEs.

The network entity may receive the configuration information and may transmit multiple instances of a PRACH message based on the configuration information. For example, the network entity may transmit, via the RO group, the multiple instances of the PRACH message. The RO group may include a quantity of valid ROs equal to the configured quantity of preamble repetitions, and the network entity may transmit a respective instance of the PRACH message in each valid RO of the RO group. Accordingly, the network entity may transmit a quantity of PRACH message instances equal to the quantity of preamble repetitions indicated by the configuration information. Based on the RO group including at least one SBFD RO, the network entity may perform RACH preamble repetition via one or more SBFD symbols, improving the reliability, latency, and resource utilization associated with random access procedures.

Aspects of the disclosure are initially described in the context of wireless communication systems. Additional aspects of the disclosure are described with reference to RACH configurations and a process flow. Aspects of the disclosure are further illustrated by and described with reference to apparatus diagrams, system diagrams, and flowcharts that relate to RACH preamble repetition for SBFD operation.

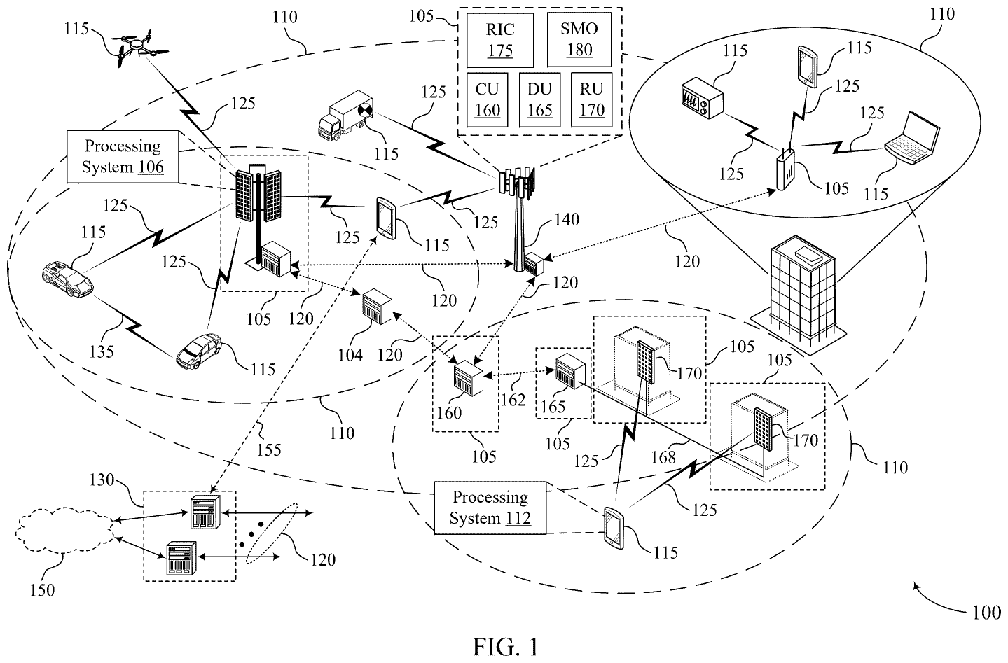

FIG. 1 shows an example of a wireless communication system 100 that supports RACH preamble repetition for SBFD operation in accordance with one or more aspects of the present disclosure. The wireless communication system 100 may include one or more devices, such as one or more network entities. A network entity may be an example of a network device (e.g., network entities 105), a UE 115, or a core network 130. In some aspects, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network entity 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some aspects, the first communication interface may be an interface configured to receive input information, and the information may be provided to the processing system. In some aspects, the second system interface may be configured to transmit information output from the chip or modem. The second communication interface may also obtain or receive input information, and the first communication interface may also output, transmit, or provide information.

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communication system 100 (e.g., other wireless communication devices, including UEs 115 or network entities 105), as shown in FIG. 1.

As described herein, a node of the wireless communication system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some aspects, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (NB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an IAB network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a CU, such as a CU 160, a DU, such as a DU 165, an RU, such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities based on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communication systems (e.g., the wireless communication system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some aspects, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an IoT device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some aspects, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communication system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communication system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communication system 100 (e.g., the network entities 105, the UEs 115, or both) may have hardware configurations that support communications using a particular carrier bandwidth or may be configurable to support communications using one of a set of carrier bandwidths. In some aspects, the wireless communication system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communication resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ}may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., based on the length of the cyclic prefix prepended to each symbol period). In some wireless communication systems, such as the wireless communication system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some aspects, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some aspects, a network entity 105 (e.g., a base station 140, an RU 170) may be movable and therefore provide communication coverage for a moving coverage area, such as the coverage area 110. In some aspects, coverage areas 110 (e.g., different coverage areas) associated with different technologies may overlap, but the coverage areas 110 (e.g., different coverage areas) may be supported by the same network entity (e.g., a network entity 105). In some other aspects, overlapping coverage areas, such as a coverage area 110, associated with different technologies may be supported by different network entities (e.g., the network entities 105). The wireless communication system 100 may include, for example, a heterogeneous network in which different types of the network entities 105 support communications for coverage areas 110 (e.g., different coverage areas) using the same or different RATs.

The wireless communication system 100 may be configured to support ultra-reliable communications or low-latency communications, or various combinations thereof. For example, the wireless communication system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to one or more of the UEs 115 in the group. In some aspects, a network entity 105 may facilitate the scheduling of resources for D2D communications. In some other aspects, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communication system 100 may utilize both licensed and unlicensed RF spectrum bands. For example, the wireless communication system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communication system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some aspects, a device may support same-slot HARQ feedback, in which case the device may provide HARQ feedback in a specific slot for data received via a previous symbol in the slot. In some other aspects, the device may provide HARQ feedback in a subsequent slot, or according to some other time interval.

In some wireless communication systems, a UE 115 (e.g., an example of a first network entity) may perform a random access procedure to establish a connection with the wireless network, for example, via a network entity 105 (e.g., an example of a second network entity). The UE 115 may trigger the random access procedure with the network entity 105 based on a request in a PRACH transmission (e.g., via higher layer signaling) or based on a physical downlink control channel (PDCCH) order for a cell.

The random access procedure may involve an exchange of RACH messages between the UE 115 (e.g., the first network entity) and the network entity 105 (e.g., the second network entity). In a four-step random access procedure, the UE 115 may transmit a RACH Message 1 (Msg1) including a RACH preamble to the network entity 105, and the network entity 105 may respond with a random access response (RAR) message, which may be referred to as a RACH Message 2 (Msg2). The RAR message may include a RACH preamble identifier (RAPID) corresponding to the RACH preamble and an uplink grant. The UE 115 may transmit a RACH Message 3 (Msg3) including physical uplink shared channel (PUSCH) data via resources granted by the uplink grant. The network entity 105 may respond with a RACH Message 4 (Msg4) for contention resolution to complete the random access procedure and establish a connection between the UE 115 and the network entity 105. Alternatively, in a two-step random access procedure, the UE 115 may transmit a RACH Message A (MsgA) including the RACH preamble and the PUSCH data, and the network entity 105 may respond with a RACH Message B (MsgB) including the RAR message and contention resolution information.

The network entity 105 may configure the UE 115 with RACH parameters to perform the random access procedure. For example, the network entity 105 may transmit configuration information to the UE 115 for PRACH transmission for a cell (e.g., the cell served by the network entity 105). The network entity 105 may transmit the configuration information via higher layer signaling, such as via an RRC message or a broadcast signal (e.g., a system information block (SIB) 1). In some aspects, the configuration information may include indications of a preamble index, a preamble subcarrier spacing (SCS), a target transmission power for PRACH transmission (e.g., a P_{PRACH,target} value), a corresponding random access radio network temporary identifier (RA-RNTI) if applicable, a PRACH resource or set of PRACH resources for the cell, or any combination thereof. Additionally, or alternatively, the configuration information may indicate a quantity of preamble repetitions,

$${N}_{preamble}^{rep} ,$$

for the PRACH transmission. The indicated quantity of preamble repetitions may be greater than one

$$( e . g . , {N}_{preamble}^{rep} > 1 )$$

if the UE 115 supports transmission of the PRACH message with repetitions.

The UE 115 (e.g., the first network entity) may transmit one or more instances of a PRACH message based on the indicated quantity of preamble repetitions,

$${N}_{preamble}^{rep} .$$

An instance of the PRACH message may be an example of a RACH Msg1,a RACH MsgA, a RACH preamble, or some other portion of a RACH Msg1 or RACH MsgA transmitted via a valid PRACH occasion (e.g., an RO). For example, the UE 115 may transmit a quantity of instances of the PRACH message equal to the indicated quantity of preamble repetitions. If the configuration information indicates

$${N}_{preamble}^{rep} = 1$$

(e.g., the quantity of preamble repetitions is set to one), the UE 115 may transmit a single instance of the PRACH message via a single valid PRACH occasion (e.g., a single RO). Alternatively, if the configuration information indicates

$${N}_{preamble}^{rep} > 1$$

(e.g., the quantity of preamble repetitions is greater then one), the UE 115 may transmit a set of multiple instances of the PRACH message via a set of valid PRACH occasions (e.g., a set of ROs corresponding to an RO group), where the quantity of transmitted instances of the PRACH message and the quantity of valid PRACH occasions in the set are both equal to the quantity of preamble repetitions, N_{preamble}^{rep}.

The UE 115 may transmit the one or more PRACH message instances based on the configuration information. For example, the UE 115 may transmit a PRACH message instance for a cell using a selected PRACH format, using a transmission power in accordance with the configured target transmission power for PRACH transmission, via the configured PRACH resource

$$( e . g . , if {N}_{preamble}^{rep} = 1 )$$

or set

$${N}_{preamble}^{rep}$$

PRACH resources

$$( e . g . , if {N}_{preamble}^{rep} > 1 )$$

using a same spatial filter (e.g., corresponding to a same transmit beam), or any combination thereof based on the configuration information. The set of N_{preamble}^{rep} PRACH resources may correspond to a single RO group. An RO group may be a set of

$${N}_{preamble}^{rep}$$

valid PRACH occasions that are consecutive in time, use the same frequency resources, and are associated with the same one or more synchronization signal (SS)/physical broadcast channel (PBCH) block (SSB) indexes, where each SSB index may be associated with a same RACH preamble index for the valid PRACH occasions within the set. The configuration information may configure one or more RO groups for the UE 115, and the UE 115 may select, or otherwise determine, an RO group to use for the PRACH transmission. For PRACH transmission with RACH preamble repetitions, the UE 115 may determine a time period associated with preamble repetitions. The time period, starting from frame 0, may be a smallest integer number of association pattern periods such that at least one set of valid PRACH occasions for each of the

$${N}_{Tx}^{SSB}$$

SSB indexes can be determined within the time period for all configured quantities of preamble repetitions (e.g., one, two, four, or eight preamble repetitions). The sets of valid PRACH occasions for each configured quantity of preamble repetitions may repeat per time period.

In some aspects, the network entity 105 (e.g., the second network entity) may configure the UE 115 (e.g., the first network entity) with an RO group including at least one SBFD RO. An SBFD RO may be an example of a valid resource for PRACH transmission within a subband configured for uplink transmission within an SBFD symbol. Additionally, the network entity 105 may configure the UE 115 with a quantity of preamble repetitions greater than one, such that the UE 115 may transmit multiple instances of the PRACH message via one or more SBFD ROs, one or more TDD ROs (e.g., ROs within an uplink symbol), or a combination thereof. The UE 115 may perform RACH preamble repetition for SBFD operation (e.g., via the one or more SBFD ROs) based on the configuration.

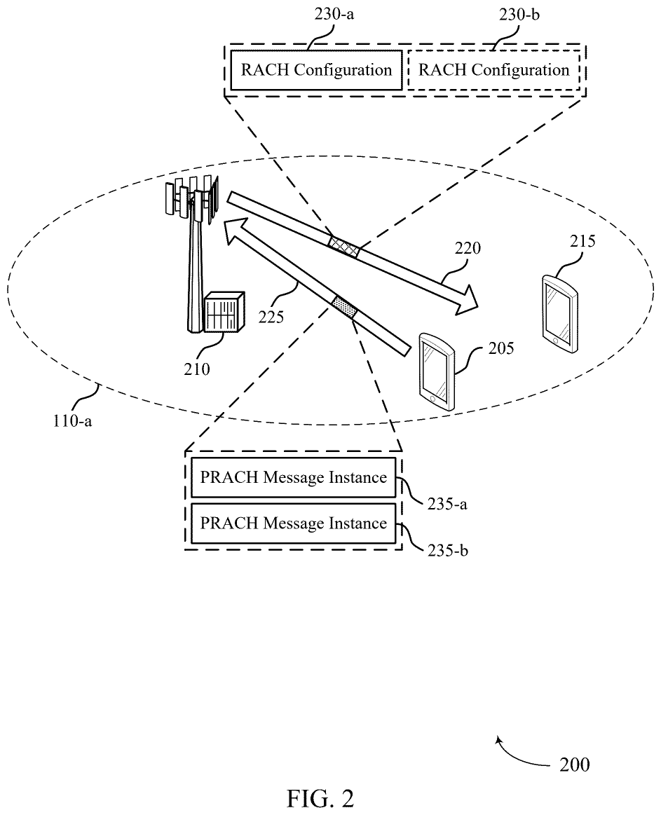

FIG. 2 shows an example of a wireless communication system 200 that supports RACH preamble repetition for SBFD operation in accordance with one or more aspects of the present disclosure. The wireless communication system 200 may be an example of a wireless communication system 100 as described herein with reference to FIG. 1. The wireless communication system 200 may include a first network entity 205, a second network entity 210, and a third network entity 215. The first network entity 205 may be an example of an SBFD-aware UE, such as a UE 115 as described herein with reference to FIG. 1. An SBFD-aware UE may perform uplink transmissions via an uplink subband of an SBFD symbol. The second network entity 210 may be an example of a network entity 105 providing network coverage for a coverage area 110-a as described herein with reference to FIG. 1. The third network entity 215 may be an example of a non-SBFD-aware UE (e.g., a “legacy” UE), such as a UE 115 as described herein with reference to FIG. 1. In some aspects, a non-SBFD-aware UE may handle an SBFD symbol the same as a downlink symbol. The first network entity 205 may support random access operations via SBFD symbols.

In some aspects, the first network entity 205 may support a random access procedure while operating in an RRC connected mode. Additionally, or alternatively, the first network entity 205 may support the random access procedure while operating in an RRC idle mode or an RRC inactive mode. The first network entity 205 may perform PRACH transmission via SBFD symbols, TDD symbols (e.g., uplink symbols), or a combination thereof. In some aspects, the first network entity 205 may support RACH preamble repetition for PRACH transmission via SBFD symbols or across SBFD and non-SBFD (e.g., TDD) symbols based on a RACH configuration.

The second network entity 210 may transmit configuration information to the first network entity 205 via a downlink channel 220 that indicates one or more RACH configurations for the first network entity 205. In some aspects, the second network entity 210 may transmit a single RACH configuration 230-a that is applicable to both SBFD and non-SBFD (e.g., TDD) symbol types. The second network entity 210 may improve a signaling overhead associated with RACH configuration based on using a single RACH configuration 230-a for both SBFD-aware UEs (e.g., the first network entity 205) and non-SBFD-aware UEs (e.g., the third network entity 215). The single RACH configuration 230-a may configure one or more valid ROs within an uplink subband of SBFD symbols, one or more valid ROs within non-SBFD uplink or flexible symbols, or a combination thereof. An SBFD-aware UE (e.g., the first network entity 205) and a non-SBFD-aware UE (e.g., the third network entity 215) receiving the single RACH configuration 230-a may determine different valid ROs based on the same RACH configuration 230-a. For example, the first network entity 205 may determine valid ROs within SBFD symbols, uplink symbols, or both based on the single RACH configuration 230-a. The third network entity 215 may determine the valid ROs within the uplink and flexible symbols (but not the SBFD symbols) based on the single RACH configuration 230-a. In some aspects, a non-SBFD-aware UE may leverage random access procedures via SBFD symbols if the SBFD ROs are configured in SBFD-flexible (FL) symbols. To support the single RACH configuration 230-a, RACH configurations may be enhanced to support indicating SBFD ROs and SBFD-aware UEs may follow RO validity rules and SSB-to-RO mappings for SBFD symbols.

In some other aspects, the second network entity 210 may transmit separate RACH configurations for SBFD-aware UEs and for non-SBFD-aware UEs. For example, the second network entity 210 may transmit a first RACH configuration 230-a corresponding to a first duplex symbol type (e.g., SBFD) and may transmit a second RACH configuration 230-b corresponding to a second, different duplex symbol type (e.g., TDD). In some cases, the second RACH configuration 230-b for the TDD symbol type may be referred to as a “legacy” RACH configuration. The separate RACH configurations may configure different PRACH parameters. For example, the first RACH configuration 230-a and the second RACH configuration 230-b may indicate different RO time resources, different RO frequency resources, different preambles, different transmit power configurations, or any combination thereof. Additionally, or alternatively, the first RACH configuration 230-a and the second RACH configuration 230-b may support independent SSB-to-RO mappings. An SBFD-aware UE (e.g., the first network entity 205) may receive the first RACH configuration 230-a and may determine valid ROs within an uplink subband of SBFD symbols. A non-SBFD-aware UE (e.g., the third network entity 215) or an SBFD-aware UE may receive the second RACH configuration 230-b and may determine valid ROs within uplink symbols. Accordingly, the second RACH configuration 230-b may be an example of an “RO-Config1” for TDD and the first RACH configuration 230-a may be an example of an “RO-Config2” for SBFD. The SBFD-aware UEs may follow RO validity rules for SBFD symbols and may select an RO configuration from the first RACH configuration 230-a and the second RACH configuration 230-b to use for PRACH transmission. In some aspects, an SBFD-aware UE may switch between the different RACH configurations.

The RACH configuration 230-a may indicate a quantity of preamble repetitions,

$${N}_{preamble}^{rep} ,$$

for SBFD-aware UEs. In some aspects, the second network entity 210 may transmit a single RACH configuration 230-a indicating a single quantity of preamble repetitions for SBFD-aware and non-SBFD-aware UEs. In some other aspects, the second network entity 210 may transmit a single RACH configuration 230-a indicating a first quantity of preamble repetitions

$$( e . g . , {N}_{preamble , SBFD}^{rep} )$$

for SBFD-aware UEs and a second quantity of preamble repetitions

$$( e . g . , {N}_{preamble , TDD}^{rep} )$$

for non-SBFD-aware UEs, where the first quantity may be the same or different than the second quantity. In yet some other aspects, the second network entity 210 may transmit a first RACH configuration 230-a indicating a first quantity of preamble repetitions

$$( e . g . , {N}_{preamble , SBFD}^{rep} )$$

for SBFD symbols and may transmit a second RACH configuration 230-b indicating a second quantity of preamble repetitions

$$( e . g . , {N}_{preamble , TDD}^{rep} )$$

for uplink and/or flexible (e.g., TDD) symbols, where the first quantity may be the same or different than the second quantity. Accordingly, the first network entity 205 may receive the RACH configuration 230-a and may determine a quantity of PRACH message instances to transmit based on the quantity of preamble repetitions indicated by the RACH configuration 230-a. For example, the first network entity 205 may transmit a quantity of instances of the PRACH message equal to the indicated quantity of preamble repetitions

$$( e . g . , {N}_{preamble}^{rep} or {N}_{preamble , SBFD}^{rep} ) .$$

The first network entity 205 may transmit a first PRACH message instance 235-a and a second PRACH message instance 235-b via a PRACH (e.g., an uplink channel 225) based on the quantity of preamble repetitions being configured to two

$$( e . g . , {N}_{preamble}^{rep} = 2 ) .$$

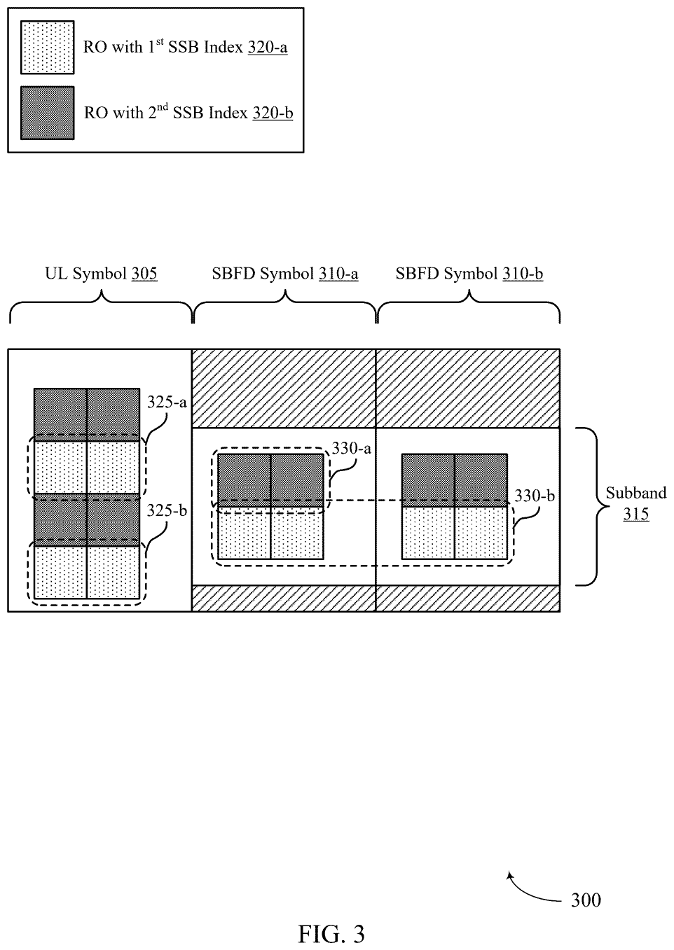

supported, such as one (e.g., corresponding to a single PRACH message instance), four, eight, or any other value. The first network entity 205 may transmit the set of multiple instances of the PRACH message via one or more SBFD symbols, one or more uplink (e.g., TDD) symbols, or a combination thereof based on the specific RACH configuration 230-a. Example RACH configurations are described in more detail with reference to FIGS. 3 through 5.

Supporting RACH preamble repetition via SBFD symbols may improve the reliability and latency of random access procedures for SBFD-aware UEs. For example, the first network entity 205 may transmit one or more instances of PRACH messages via one or more SBFD symbols that precede one or more TDD symbols. By transmitting the PRACH message instances via the SBFD symbols, rather than waiting for the TDD symbols, the first network entity 205 may reduce the latency involved in transmitting the PRACH message instances. Additionally, or alternatively, by transmitting multiple PRACH message instances, rather than a single PRACH message, the first network entity 205 may improve a likelihood that the second network entity 210 successfully receives at least one of the PRACH message instances and responds with a RAR message, improving the reliability of the random access procedure.

FIG. 3 shows an example of a RACH configuration 300 that supports RACH preamble repetition for SBFD operation in accordance with one or more aspects of the present disclosure. The RACH configuration 300 may be an example of a RACH configuration 230-a or a RACH configuration 230-b, as described herein with reference to FIG. 2. The RACH configuration 300 may support the same duplex symbol type (e.g., either SBFD symbols or TDD symbols) within a respective RO group. Accordingly, a network entity, such as a UE 115 or a network entity 205 as described herein with reference to FIGS. 1 and 2, that transmits multiple instances of a PRACH message may transmit the multiple instances within SBFD ROs or TDD ROs, but not both.

The RACH configuration 300 (e.g., a single RACH configuration or multiple RACH configurations) may configure one or more RO groups for RACH preamble repetition. A respective RO group may correspond to SBFD symbols or non-SBFD symbols, but not both. For example, the RACH configuration 300 may correspond to an uplink symbol 305 (e.g., a TDD symbol), a first SBFD symbol 310-a, and a second SBFD symbol 310-b. The SBFD symbols may support both uplink and downlink communications. For example, the SBFD symbols may support uplink communications via a subband 315 and may support downlink communications via other frequency resources. The uplink signal-to-interference-plus-noise ratio (SINR) may be different for the SBFD symbols as compared to the TDD symbols. Accordingly, having different RO groups for the SBFD symbols versus the TDD symbols may reduce complexity by avoiding managing different SINR values for different ROs within the same group.

The RACH configuration 300 may include two different SSB indexes, SSB index number 0 and SSB index number 1 (or any other quantity of SSB indexes or any other SSB index values). In some aspects, the uplink symbol 305 may include four frequency division multiplexed (FDMed) ROs, while the SBFD symbols may include two FDMed ROs within the subband 315. The RO groups may include ROs with the first SSB index 320-a, ROs with the second SSB index 320-b, or both. An RO group may include ROs with SSB indexes that correspond to a same RACH preamble. For example, if the first SSB index corresponds to a different RACH preamble than the second SSB index, an RO group may include either ROs with the first SSB index 320-a or ROs with the second SSB index 320-b, but not both. Alternatively, if the first SSB index corresponds to a same RACH preamble as the second SSB index, an RO group may include ROs with the first SSB index 320-a, ROs with the second SSB index 320-b, or a combination thereof.

The RACH configuration 300 may support different PRACH sequence formats for TDD ROs and SBFD ROs. In some aspects, the RACH configuration 300 may support different transmit beams for TDD ROs and SBFD ROs. Additionally, or alternatively, the RACH configuration 300 may support different set of RACH preambles for TDD ROs and SBFD ROs of the same PRACH format.

In some aspects, as illustrated in FIG. 3, an RO group for PRACH repetition may include the same duplex symbol type. For example, a first RO group and a second RO group may be examples of TDD RO groups (e.g., a first TDD RO group 325-a and a second TDD RO group 325-b) and may include TDD ROs (but not SBFD ROs). A third RO group and a fourth RO group may be examples of SBFD RO groups (e.g., an SBFD RO group 330-a and an SBFD RO group 330-b) and may include SBFD ROs (but not TDD ROs). In some such aspects, no RO group may span across a combination of TDD ROs and SBFD ROs. That is, an RO group may be a set of

$${N}_{preamble}^{rep}$$

valid PRACH occasions that are consecutive in time in non-SBFD symbols or in SBFD symbols (but not both), use the same frequency resources, and are associated with the same one or more SSB indexes, where each SSB index may be associated with a same RACH preamble index for the valid PRACH occasions within the set.

In some aspects, the configured quantity of preamble repetitions may be the same for TDD ROs and SBFD ROs. For example, the RACH configuration 300 may indicate a quantity of preamble repetitions of two

$$( e . g . , {N}_{preamble}^{rep} = 2 )$$

for both TDD and SBFD ROs. The network entity may determine a first TDD RO group 325-a with two TDD ROs, a second TDD RO group 325-b with two TDD ROs, and an SBFD RO group 330-a with two SBFD ROs.

In some cases, a quantity of consecutive SBFD symbols or slots may enable a greater quantity of consecutive ROs as compared to relatively sparser ROs in uplink (e.g., TDD) symbols or slots. In some aspects, the configured quantity of preamble repetitions may be different for TDD ROs and SBFD ROs to efficiently utilize the consecutive SBFD symbols. For example, the RACH configuration 300 may indicate a quantity of preamble repetitions of two

$$( e . g . , {N}_{preamble , TDD}^{rep} = 2 )$$

for TDD ROs and a quantity of preamble repetitions of four

$$( e . g . , {N}_{preamble , SBFD}^{rep} = 4 )$$

for SBFD ROs. The network entity may determine the first TDD RO group 325-a with two TDD ROs, the second TDD RO group 325-b with two TDD ROs, and an SBFD RO group 330-b with four SBFD ROs based on the different quantities of preamble repetitions. In some aspects, RACH configuration information (e.g., configured by an RRC configuration message or a broadcast message, such as SIB1) may include a first field indicating the quantity of preamble repetitions for TDD ROs and a second field indicating the quantity of preamble repetitions for SBFD ROs. If the second field is not configured (e.g., is blank, not included, or set to a null value), the network entity may determine to use the quantity of preamble repetitions indicated by the first field for SBFD ROs (e.g., in addition to TDD ROs, such that the same quantity of preamble repetitions is used).

In some aspects, the RACH configuration 300 may configure SBFD ROs with a relatively long PRACH sequence. For example, PRACH sequence formats 0 through 3 may span one or more ms and may include repeated RACH preambles within a single PRACH sequence. Such PRACH sequence formats may provide relatively large cell coverage based on the inherent repetition within the format, which may make further preamble repetition redundant or inefficient. In some such aspects, the SBFD ROs may not support PRACH repetition. Accordingly, the groups of ROs for PRACH repetition may occur in non-SBFD symbols (e.g., the uplink symbol 305) but not in SBFD symbols. Instead, a network entity (e.g., an SBFD-aware UE 115) may transmitting a PRACH message via an SBFD symbol may transmit a single instance of the PRACH message (e.g., with the relatively long PRACH sequence) via a single SBFD RO. In some aspects, a second network entity (e.g., a network entity 105) may transmit a separate RACH configuration for the network entity (e.g., the SBFD-aware UE 115) indicating the relatively long PRACH sequence and no preamble repetition

$$( e . g . , {N}_{preamble}^{rep} = 1 )$$

### for SBFD ROs.

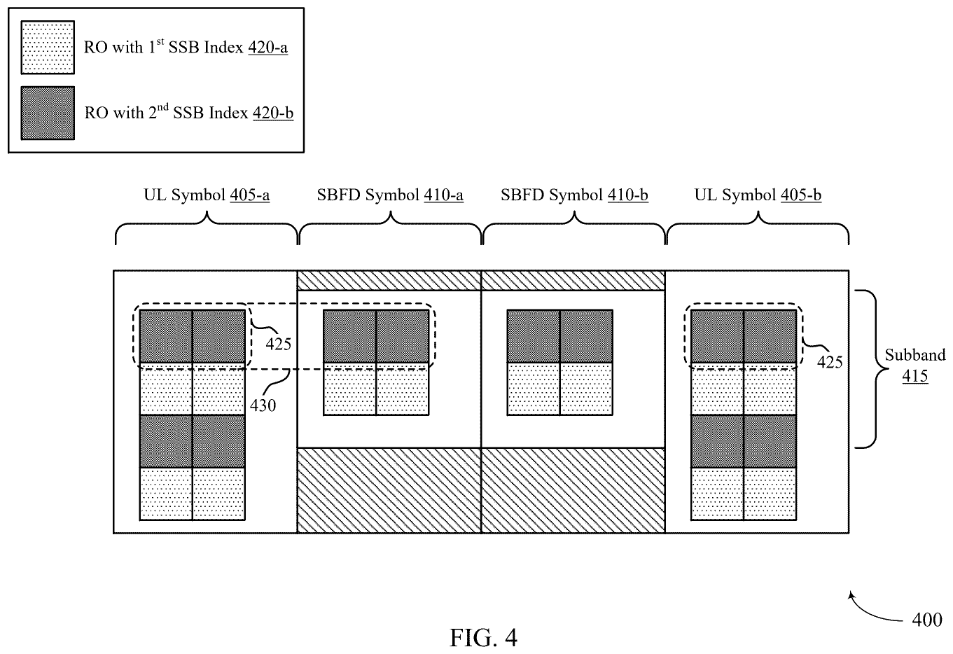

FIG. 4 shows an example of a RACH configuration 400 that supports RACH preamble repetition for SBFD operation in accordance with one or more aspects of the present disclosure. The RACH configuration 400 may be an example of a RACH configuration 230-a or a RACH configuration 230-b, as described herein with reference to FIG. 2. The RACH configuration 400 may support different duplex symbol types (e.g., a combination of SBFD and TDD symbols) within a respective RO group. Accordingly, a network entity, such as a UE 115 or a network entity 205 as described herein with reference to FIGS. 1 and 2, that transmits multiple instances of a PRACH message may transmit the multiple instances within one or more SBFD ROs, one or more TDD ROs, or a combination thereof.

The RACH configuration 400 (e.g., a single RACH configuration or multiple RACH configurations) may configure one or more RO groups for RACH preamble repetition. A respective RO group may correspond to any combination of SBFD and non-SBFD symbols. For example, the RACH configuration 400 may correspond to a first uplink symbol 405-a (e.g., a TDD symbol), a first SBFD symbol 410-a, a second SBFD symbol 410-b, and a second uplink symbol 405-b. The SBFD symbols may support uplink communications via a subband 415 and may support downlink communications via other frequency resources. The RACH configuration 400 may include two different SSB indexes, SSB index number 0 and SSB index number 1 (or any other quantity of SSB indexes or any other SSB index values). In some aspects, the uplink symbols may include four FDMed ROs, while the SBFD symbols may include two FDMed ROs within the subband 415. The RO groups may include ROs with the first SSB index 420-a, ROs with the second SSB index 420-b, or both.

The RACH configuration 400 may support reduced latency of PRACH repetitions by utilizing SBFD resources for PRACH repetition. Additionally, or alternatively, the RACH configuration 400 with PRACH repetitions across different duplex symbol types may enable relatively greater quantities of repetitions within a same time period as compared to PRACH repetitions across the same duplex symbol types. For example, a group of valid ROs for

$${N}_{preamble}^{rep}$$

RACH preamble repetitions may span across SBFD symbols, non-SBFD symbols, or both. For example, the RACH configuration 400 may include an RO group 430 including two TDD ROs in the first uplink symbol 405-a and two SBFD ROs in the first SBFD symbol 410-a. These TDD ROs and SBFD ROs may correspond to a same set of frequency resources and SSB indexes that correspond to the same RACH preamble. An RO group may be a set of

$${N}_{preamble}^{rep}$$

valid PRACH occasions that are consecutive in time across non-SBFD symbols and/or SBFD symbols, use the same frequency resources, and are associated with the same one or more SSB indexes, where each SSB index may be associated with a same RACH preamble index for the valid PRACH occasions within the set.

A network entity (e.g., an SBFD-aware UE) may determine whether repetition across different duplex symbol types is supported or restricted. In some aspects, a second network entity (e.g., a network entity 105) may configure the network entity via higher layer parameters (e.g., RRC signaling, SIB1) with RO groups that support different duplex symbol types or a same duplex symbol type. In some other aspects, the network entity (e.g., the SBFD-aware UE) may implicitly determine whether RO groups support different duplex symbol types or a same duplex symbol type based on a comparison of PRACH parameters for SBFD ROs and TDD ROs. For example, RO groups may support a single duplex symbol type (e.g., SBFD ROs or TDD ROs, but not both) if the network entity is configured with different preambles, different transmit beams, different PRACH configurations, different starting resource blocks for ROs, or any combination thereof for SBFD versus TDD symbols.

In some aspects, different network entities may determine different RO groups based on the RACH configuration 400. For example, RACH configuration 400 may indicate a quantity of preamble repetitions of four

$$( e . g . , {N}_{preamble}^{rep} = 4 ) .$$

An SBFD-aware UE may receive the configuration information for the RACH configuration 400 and may determine an RO group 430 including both TDD and SBFD ROs. In contrast, a non-SBFD-aware UE (e.g., a legacy UE) may receiving the same configuration information for the RACH configuration 400 and may determine an RO group 425 including TDD ROs (but not SBFD ROs). Because the SBFD ROs are not valid PRACH occasions for the non-SBFD-aware UE, the four valid PRACH occasions that are consecutive in time for the non-SBFD-aware UE may include TDD ROs in the first uplink symbol 405-a and in the second uplink symbol 405-b, while the four valid PRACH occasions that are consecutive in time for the SBFD-aware UE may include TDD ROs in the first uplink symbol 405-a and SBFD ROs in the first SBFD symbol 410-a.

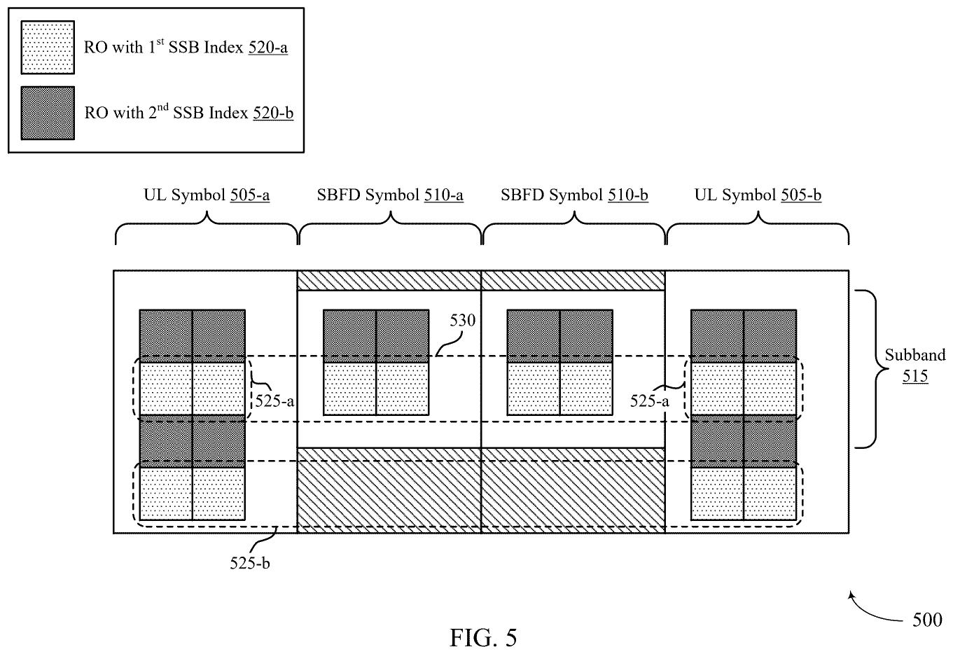

FIG. 5 shows an example of a RACH configuration 500 that supports RACH preamble repetition for SBFD operation in accordance with one or more aspects of the present disclosure. The RACH configuration 500 may be an example of a RACH configuration 230-a or a RACH configuration 230-b, as described herein with reference to FIG. 2. The RACH configuration 500 may support different duplex symbol types (e.g., a combination of SBFD and TDD symbols) within a respective RO group. Accordingly, a network entity, such as a UE 115 or a network entity 205 as described herein with reference to FIGS. 1 and 2, that transmits multiple instances of a PRACH message may transmit the multiple instances within one or more SBFD ROs, one or more TDD ROs, or a combination thereof.

The RACH configuration 500 (e.g., a single RACH configuration or multiple RACH configurations) may configure one or more RO groups for RACH preamble repetition. A respective RO group may correspond to any combination of SBFD and non-SBFD symbols. For example, the RACH configuration 500 may correspond to a first uplink symbol 505-a (e.g., a TDD symbol), a first SBFD symbol 510-a, a second SBFD symbol 510-b, and a second uplink symbol 505-b. The SBFD symbols may support uplink communications via a subband 515 and may support downlink communications via other frequency resources. The RACH configuration 500 may include two different SSB indexes, SSB index number 0 and SSB index number 1 (or any other quantity of SSB indexes or any other SSB index values). In some aspects, the uplink symbols may include four FDMed ROs, while the SBFD symbols may include two FDMed ROs within the subband 515. The RO groups may include ROs with the first SSB index 520-a, ROs with the second SSB index 520-b, or both.

In some aspects, configuration information indicating the RACH configuration 500 may indicate different quantities of preamble repetitions for SBFD-aware UEs and for non-SBFD-aware UEs (e.g., legacy UEs). For example, the configuration information may configure a first network entity (e.g., an SBFD-aware UE) with a quantity of preamble repetitions of eight

$$( e . g . , {N}_{preamble , SBFD}^{rep} = 8 ) .$$

The configuration information may configure a second network entity (e.g., a non-SBFD-aware UE) with a quantity of preamble repetitions of four

$$( e . g . , {N}_{preamble , TDD}^{rep} = 4 ) .$$

Accordingly, the first network entity may determine an RO group 530 for RACH preamble repetition including four TDD ROs in the uplink symbols and four SBFD ROs in the SBFD symbols for the eight PRACH message instances (e.g., based on the quantity of preamble repetitions of eight). In contrast, the second network entity may determine an RO group 525-a or an RO group 525-b for RACH preamble repetition including four TDD ROs in the uplink symbols for the four PRACH message instances (e.g., based on the quantity of preamble repetitions of four).

In some aspects, the configuration information may configure separate preambles via shared ROs for the SBFD-aware and non-SBFD-aware UEs. For example, the RO group 530 may share TDD ROs with the RO group 525-a. However, these RO groups may use different RACH preambles, different quantities of preamble repetitions, or both. In some other aspects, the configuration information may configure multiple PRACH repetitions via separate ROs for the SBFD-aware and non-SBFD-aware UEs. For example, the ROs of the RO group 530 may be separate from (e.g., distinct from, or otherwise non-overlapping with) the ROs of the RO group 525-b. These RO groups may use the same or different RACH preambles, different quantities of preamble repetitions, or any combination thereof.

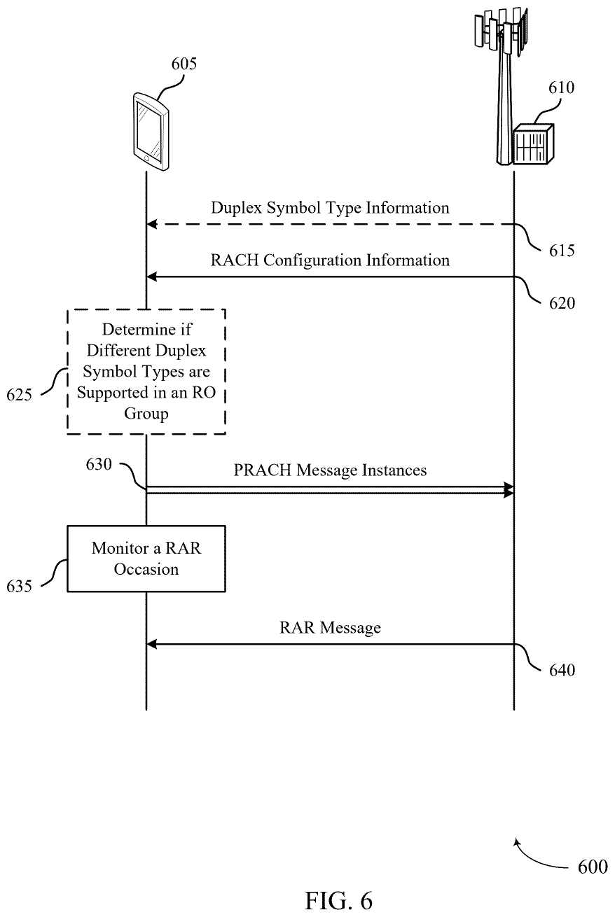

FIG. 6 shows an example of a process flow 600 that supports RACH preamble repetition for SBFD operation in accordance with one or more aspects of the present disclosure. The process flow 600 may include a first network entity 605 (e.g., a UE 115, such as an SBFD-aware UE) and a second network entity 610 (e.g., a network entity 105). The second network entity 610 may configure the first network entity 605 with a RACH configuration, such as a RACH configuration 300, a RACH configuration 400, or a RACH configuration 500 as described with reference to FIGS. 3 through 5. The first network entity 605 may perform RACH preamble repetition via SBFD ROs based on the RACH configuration. In the following description of the process flow 600, operations performed by the first network entity 605 and the second network entity 610 may be performed in a different order than is shown. Some operations may be omitted from the process flow 600, and other operations may be added to the process flow 600. Further, although some operations or signaling may be shown to occur at different times for discussion purposes, these operations may occur at the same time. Additionally, or alternatively, other network devices may perform aspects of the process flow 600.

In some aspects, at 615, the second network entity 610 may transmit information that indicates whether RO groups support different duplex symbol types. For example, the information may indicate that RO groups support a single, same duplex symbol type (e.g., an RO group has SBFD ROs or TDD ROs, but not both). Alternatively, the information may indicate that RO groups support different duplex symbol types (e.g., an RO group may include both SBFD and TDD ROs). In some aspects, the second network entity 610 may transmit the information with RACH configuration information, for example, in an RRC message or SIB1 signaling. The first network entity 605 may receive the information and determine whether the RO groups support the same or different duplex symbol types based on the information.

At 620, the second network entity 610 may transmit RACH configuration information. In some aspects, the RACH configuration information may be included within an RRC message or SIB1 signaling. The first network entity 605 may receive the RACH configuration information and determine an RO group for PRACH transmission based on the RACH configuration information. The RACH configuration information may indicate an RO group and a quantity of preamble repetitions. For example, the RACH configuration information may configure or otherwise indicate a set of ROs corresponding to the RO group and a value,

$${N}_{preamble}^{rep} ,$$

indicating the quantity of preamble repetitions. The RO group may include a set of valid PRACH occasions (e.g., consecutive in time) with a quantity of ROs equal to the quantity of preamble repetitions.

The set of valid PRACH occasions may include at least one SBFD RO that is valid for the PRACH transmission. In some aspects, the RO group for the first network entity 605 may be an example of a first RO group that includes SBFD ROs, and the RACH configuration information may indicate a second RO group that includes TDD ROs. In some such aspects, the first RO group and the second RO group may correspond to different PRACH transmission parameters, such as different PRACH sequence formats, different transmit beams, different transmit powers, different sets of frequency resources, different RACH preambles, different quantities of preamble repetitions, or any combination thereof. In some other aspects, the RO group may include one or more SBFD ROs and one or more TDD ROs.

In some aspects, at 625, the first network entity 605 may determine, based on a comparison of PRACH parameters configured for SBFD symbols and for non-SBFD parameters, whether RO groups support different duplex symbol types. For example, if the RACH configuration information indicates different PRACH parameters for SBFD versus non-SBFD symbols (e.g., TDD symbols), the first network entity 605 may implicitly determine that the RO groups correspond to single, same duplex symbol types (e.g., an RO group includes either SBFD ROs or TDD ROs). If the RACH configuration information indicates the same PRACH parameters for SBFD versus non-SBFD symbols (e.g., TDD symbols), the first network entity 605 may implicitly determine that the RO groups may correspond to different duplex symbol types (e.g., an RO group may include both SBFD ROs and TDD ROs).

At 630, the first network entity 605 may transmit, via the RO group, a set of multiple instances of a PRACH message based on the quantity of preamble repetitions. For example, the first network entity 605 may transmit a respective PRACH message instance via each valid RO of the RO group. In this way, the first network entity 605 may transmit a quantity of PRACH message instances equal to the configured quantity of preamble repetitions (e.g., the value of

$${N}_{preamble}^{rep} ,$$

where

$${N}_{preamble}^{rep} > 1 ) .$$

A PRACH message instance may include a RACH message (e.g., a RACH Msg1, a preamble portion of a RACH MsgA), a portion of a RACH message, a RACH preamble sequence, or any combination thereof. The first network entity 605 may transmit the respective PRACH message instances using the same PRACH transmission parameters configured via the RACH configuration information. For example, the first network entity 605 may transmit each instance of the PRACH message using a same PRACH sequence format, a same transmit beam, a same transmit power, a same set of frequency resources, a same RACH preamble, or any combination thereof. In some aspects, the first network entity 605 may transmit multiple PRACH message instances prior to monitoring for an RAR message in response to the instances. The second network entity 610 may receive one or more of the PRACH message instances.

At 635, the first network entity 605 may monitor a RAR occasion for a RAR message. For example, the set of multiple instances of the PRACH message may correspond to a single RAR occasion or RAR window. The first network entity 605 may transmit the multiple PRACH message instances as part of a single random access attempt and may monitor for a single RAR message in response. At 640, the second network entity 610 may transmit a RAR message in response to at least one PRACH message instance. The first network entity 605 may receive the RAR message based on monitoring the single RAR occasion or RAR window. The RAR message may be an example of a RACH Msg2 or a RACH MsgB. The first network entity 605 and the second network entity 610 may complete the random access procedure based on the RAR message.

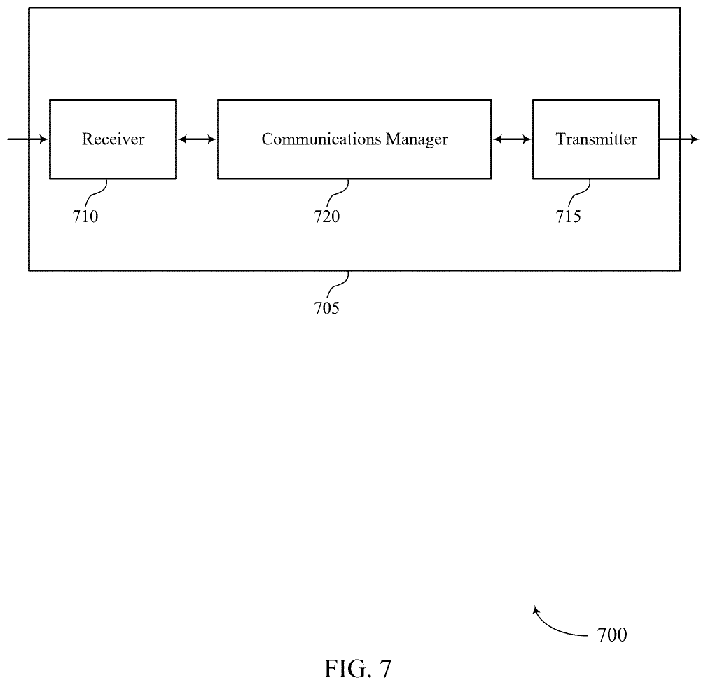

FIG. 7 shows a block diagram 700 of a device 705 that supports RACH preamble repetition for SBFD operation in accordance with one or more aspects of the present disclosure. The device 705 may be an example of aspects of a network entity, such as a UE 115 or a network entity 105, as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving, or otherwise obtaining, information such as packets, user data, control information, or any combination thereof associated with various information channels (e.g., control channels, data channels, information channels related to RACH preamble repetition for SBFD operation). Information may be passed on to other components of the device 705. The receiver 710 may utilize a single antenna or a set of multiple antennas.

The transmitter 715 may provide a means for transmitting, or otherwise outputting, signals generated by other components of the device 705. For example, the transmitter 715 may transmit information such as packets, user data, control information, or any combination thereof associated with various information channels (e.g., control channels, data channels, information channels related to RACH preamble repetition for SBFD operation). In some aspects, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of RACH preamble repetition for SBFD operation as described herein. For example, the communications manager 720, the receiver 710, the transmitter 715, or various combinations or components thereof may be capable of performing one or more of the functions described herein.

In some aspects, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The communications manager 720 is capable of, configured to, or operable to support a means for transmitting, via the RO group, a set of multiple instances of a PRACH message based on the quantity of preamble repetitions.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing associated with random access procedures and more efficient utilization of communication resources. For example, the device 705 may improve the reliability of random access procedures by supporting preamble repetitions via SBFD resources, reducing processing resources used for repeating failed random access procedures. Additionally, or alternatively, the device 705 may improve resource utilization by using SBFD symbols for random access procedures.

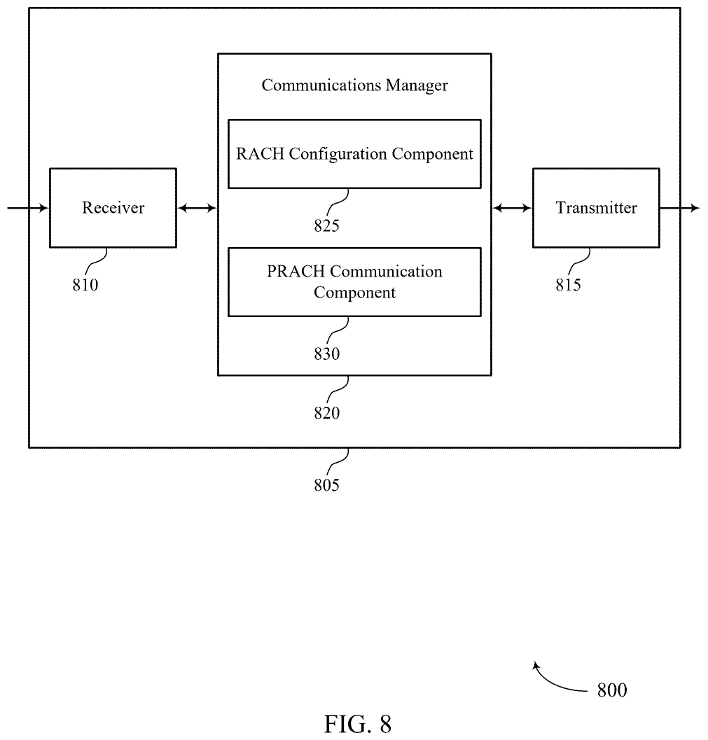

FIG. 8 shows a block diagram 800 of a device 805 that supports RACH preamble repetition for SBFD operation in accordance with one or more aspects of the present disclosure. The device 805 may be an example of aspects of a device 705 or a network entity, such as a UE 115 or a network entity 105, as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to RACH preamble repetition for SBFD operation). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to RACH preamble repetition for SBFD operation). In some aspects, the transmitter 815 may be co-located with a receiver 810 in a transceiver module. The transmitter 815 may utilize a single antenna or a set of multiple antennas.

The device 805, or various components thereof, may be an example of means for performing various aspects of RACH preamble repetition for SBFD operation as described herein. For example, the communications manager 820 may include a RACH configuration component 825 a PRACH communication component 830, or any combination thereof. The communications manager 820 may be an example of aspects of a communications manager 720 as described herein. In some aspects, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The RACH configuration component 825 is capable of, configured to, or operable to support a means for receiving configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The PRACH communication component 830 is capable of, configured to, or operable to support a means for transmitting, via the RO group, a set of multiple instances of a PRACH message based on the quantity of preamble repetitions.

Additionally, or alternatively, the RACH configuration component 825 is capable of, configured to, or operable to support a means for causing transmission of configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The PRACH communication component 830 is capable of, configured to, or operable to support a means for receiving, via the RO group, at least one instance of a set of multiple instances of a PRACH message based on the quantity of preamble repetitions.

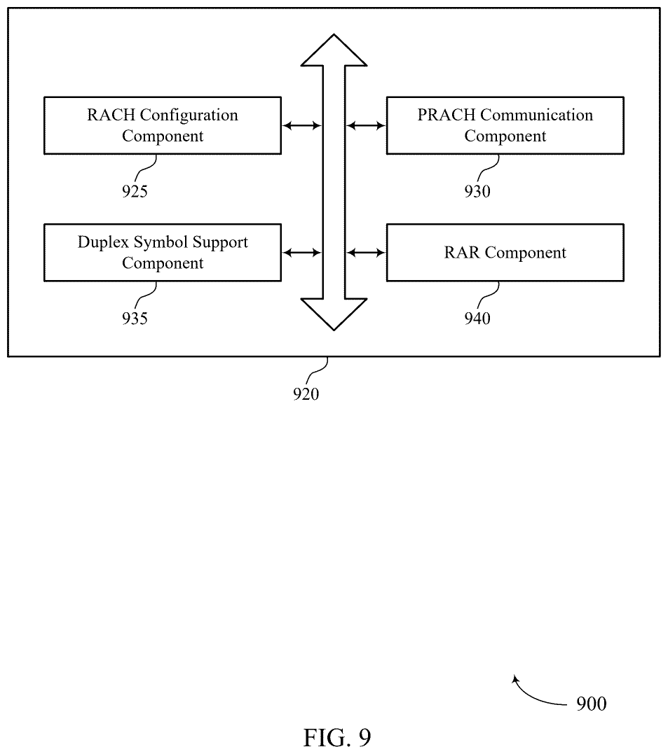

FIG. 9 shows a block diagram 900 of a communications manager 920 that supports RACH preamble repetition for SBFD operation in accordance with one or more aspects of the present disclosure. The communications manager 920 may be an example of aspects of a communications manager 720, a communications manager 820, or both, as described herein. The communications manager 920, or various components thereof, may be an example of means for performing various aspects of RACH preamble repetition for SBFD operation as described herein. For example, the communications manager 920 may include a RACH configuration component 925, a PRACH communication component 930, a duplex symbol support component 935, an RAR component 940, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The RACH configuration component 925 is capable of, configured to, or operable to support a means for receiving configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The PRACH communication component 930 is capable of, configured to, or operable to support a means for transmitting, via the RO group, a set of multiple instances of a PRACH message based on the quantity of preamble repetitions.

In some aspects, the RO group is a first RO group, where the first RO group includes SBFD ROs. In some such aspects, the configuration information further indicates a second RO group, where the second RO group includes TDD ROs. In some aspects, the configuration information separately indicates: a first PRACH sequence format, a first transmit beam, a first set of frequency resources, a first RACH preamble, or any combination thereof that correspond to the first RO group; and a second PRACH sequence format different from the first PRACH sequence format, a second transmit beam different from the first transmit beam, a second set of frequency resources different from the first set of frequency resources, a second RACH preamble different from the first RACH preamble, or any combination thereof that correspond to the second RO group. In some aspects, the quantity of preamble repetitions is a first quantity of preamble repetitions for the SBFD ROs. In some such aspects, the configuration information separately indicates a second quantity of preamble repetitions for the TDD ROs.

In some aspects, the configuration information indicates, for the first RO group and the second RO group, a same PRACH sequence format, a same transmit beam, a same set of frequency resources, a same RACH preamble, or any combination thereof. In some aspects, the quantity of preamble repetitions corresponds to both the first RO group and the second RO group.

In some aspects, the RO group includes the at least one SBFD RO and at least one TDD RO.

In some aspects, the duplex symbol support component 935 is capable of, configured to, or operable to support a means for receiving information that indicates the RO group supports a same duplex symbol type. In some other aspects, the duplex symbol support component 935 is capable of, configured to, or operable to support a means for receiving information that indicates the RO group supports different duplex symbol types.

In some aspects, the duplex symbol support component 935 is capable of, configured to, or operable to support a means for determining, based on a comparison of PRACH parameters configured for SBFD symbols and for non-SBFD symbols, that the RO group supports a same duplex symbol type or different duplex symbol types. In some aspects, the PRACH parameters include a PRACH sequence format, a transmit beam, a set of frequency resources, a RACH preamble, or any combination thereof.

In some aspects, the quantity of preamble repetitions is a first quantity of preamble repetitions for the network entity that supports the at least one SBFD RO as valid for the PRACH transmission. In some aspects, the configuration information further indicates a second quantity of preamble repetitions for a second network entity that fails to recognize (e.g., does not recognize, or otherwise consider) SBFD ROs as valid for the PRACH transmission. In some aspects, the RO group for the network entity shares one or more ROs with a second RO group for the second network entity. In some such aspects, the RO group and the second RO group correspond to different RACH preambles for the one or more shared ROs. In some other aspects, first respective ROs of the RO group for the network entity are distinct from second respective ROs of a second RO group for the second network entity.

In some aspects, the RAR component 940 is capable of, configured to, or operable to support a means for receiving an RAR message based on at least one instance of the set of multiple instances of the PRACH message. In some aspects, the set of multiple instances of the PRACH message corresponds to a single RAR, and the RAR component 940 is capable of, configured to, or operable to support a means for monitoring for the RAR message via a monitoring occasion associated with the single RAR.

In some aspects, the at least one SBFD RO is within a subband configured for uplink transmission within an SBFD symbol. In some aspects, the set of valid PRACH occasions includes a set of multiple PRACH occasions that span a same set of frequency resources, correspond to a same transmit beam, correspond to a same transmit power, correspond to a same RACH preamble, or correspond to a same duplex symbol type.

In some aspects, the configuration information includes an RRC signal or a SIB.

In some aspects, a quantity of the set of multiple instances of the PRACH message is equal to the quantity of preamble repetitions. In some aspects, the quantity of preamble repetitions is greater than one. In some aspects, a quantity of occasions of the set of valid PRACH occasions is equal to the quantity of preamble repetitions.

Additionally, or alternatively, the communications manager 920 may support wireless communication in accordance with examples as disclosed herein. The RACH configuration component 925 is capable of, configured to, or operable to support a means for causing transmission of configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The PRACH communication component 930 is capable of, configured to, or operable to support a means for receiving, via the RO group, at least one instance of a set of multiple instances of a PRACH message based on the quantity of preamble repetitions.

In some aspects, the RO group is a first RO group, wherein the first RO group includes SBFD ROs, and the configuration information further indicates a second RO group, wherein the second RO group includes TDD ROs.

In some aspects, the configuration information separately indicates: a first PRACH sequence format, a first transmit beam, a first set of frequency resources, a first RACH preamble, or any combination thereof that correspond to the first RO group; and a second PRACH sequence format different from the first PRACH sequence format, a second transmit beam different from the first transmit beam, a second set of frequency resources different from the first set of frequency resources, a second RACH preamble different from the first RACH preamble, or any combination thereof that correspond to the second RO group. In some aspects, the quantity of preamble repetitions is a first quantity of preamble repetitions for the SBFD ROs. In some such aspects, the configuration information separately indicates a second quantity of preamble repetitions for the TDD ROs. In some aspects, the quantity of preamble repetitions is a first quantity of preamble repetitions for the SBFD ROs, and the configuration information separately indicates a second quantity of preamble repetitions for the TDD ROs.

In some aspects, the configuration information indicates, for the first RO group and the second RO group, a same PRACH sequence format, a same transmit beam, a same set of frequency resources, a same RACH preamble, or any combination thereof. In some aspects, the quantity of preamble repetitions corresponds to both the first RO group and the second RO group.

In some aspects, the configuration information includes an RRC signal or a SIB.

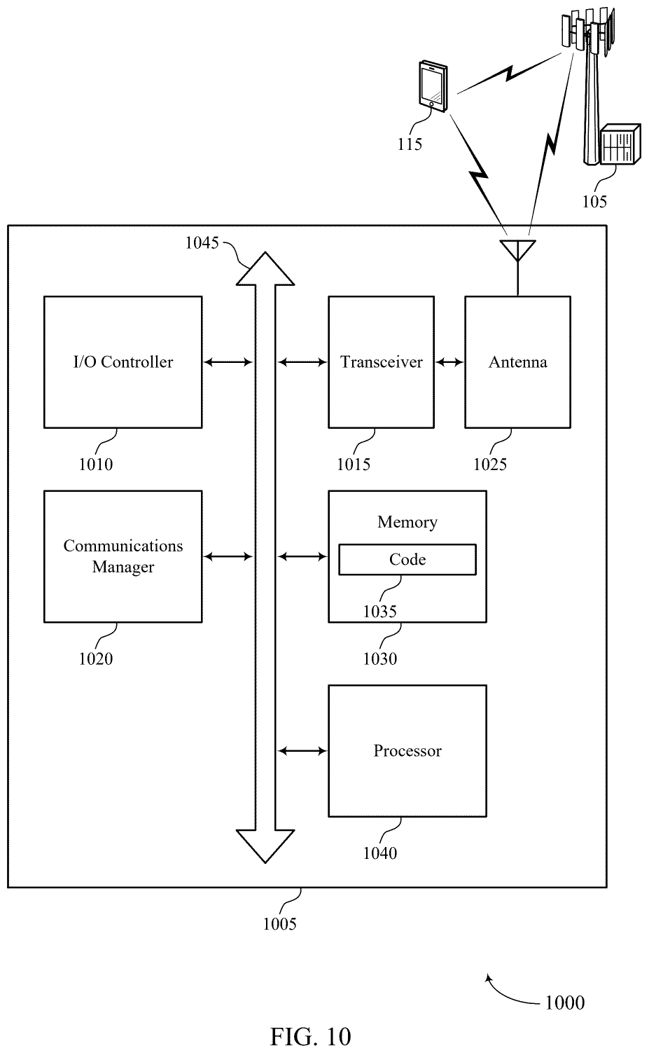

FIG. 10 shows a diagram of a system 1000 including a device 1005 that supports RACH preamble repetition for SBFD operation in accordance with one or more aspects of the present disclosure. The device 1005 may be an example of or include components of a device 705, a device 805, or a network entity, such as a UE 115 or a network entity 105, as described herein. The device 1005 may communicate (e.g., wirelessly) with one or more other devices (e.g., network entities, such as network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting RACH preamble repetition for SBFD operation). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some aspects, the at least one processor 1040 may include multiple processors and the at least one memory 1030 may include multiple memories. One or more of the multiple processors may be coupled with one or more of the multiple memories, which may, individually or collectively, be configured to perform various functions described herein. In some aspects, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The communications manager 1020 is capable of, configured to, or operable to support a means for transmitting, via the RO group, a set of multiple instances of a PRACH message based on the quantity of preamble repetitions.

Additionally, or alternatively, the communications manager 1020 is capable of, configured to, or operable to support a means for causing transmission of configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The communications manager 1020 is capable of, configured to, or operable to support a means for receiving, via the RO group, at least one instance of a set of multiple instances of a PRACH message based on the quantity of preamble repetitions.

By including or configuring the communications manager 1020 in accordance with examples as described herein, the device 1005 may support techniques for improved communication reliability (e.g., including improved connection establishment via random access procedures), reduced latency for random access procedures, and more efficient utilization of communication resources (e.g., including SBFD symbol resources).

In some aspects, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some aspects, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of RACH preamble repetition for SBFD operation as described herein, or the at least one processor 1040 and the at least one memory 1030 may be otherwise configured to, individually or collectively, perform or support such operations.

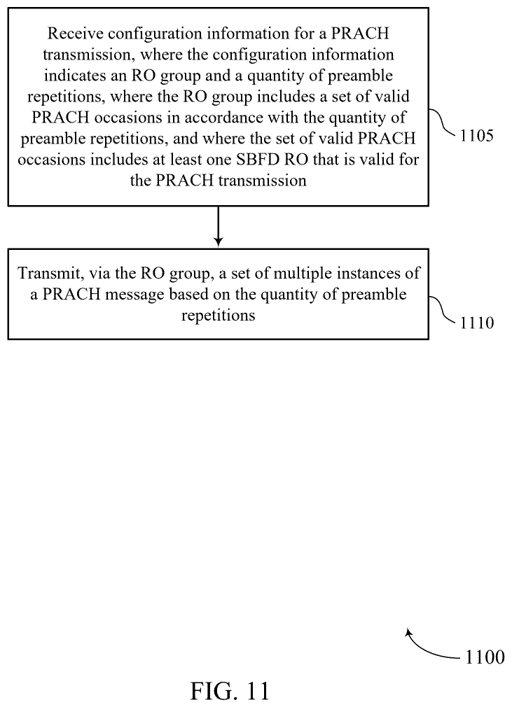

FIG. 11 shows a flowchart illustrating a method 1100 that supports RACH preamble repetition for SBFD operation in accordance with one or more aspects of the present disclosure. The operations of the method 1100 may be implemented by a network entity (e.g., a UE) or its components as described herein. For example, the operations of the method 1100 may be performed by a network entity as described with reference to FIGS. 1 through 10. In some aspects, a network entity may execute a set of instructions to control the functional elements of the network entity to perform the described functions. Additionally, or alternatively, the network entity may perform aspects of the described functions using special-purpose hardware.

At 1105, the method may include receiving configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The set of valid PRACH occasions may be in accordance with the quantity of preamble repetitions based on the set of valid PRACH occasions including a quantity of PRACH occasions equal to the quantity of preamble repetitions. The operations of 1105 may be performed in accordance with examples as disclosed herein. In some aspects, aspects of the operations of 1105 may be performed by a RACH configuration component 925 as described with reference to FIG. 9.

At 1110, the method may include transmitting, via the RO group, a set of multiple instances of a PRACH message based on the quantity of preamble repetitions. The operations of 1110 may be performed in accordance with examples as disclosed herein. In some aspects, aspects of the operations of 1110 may be performed by a PRACH communication component 930 as described with reference to FIG. 9.

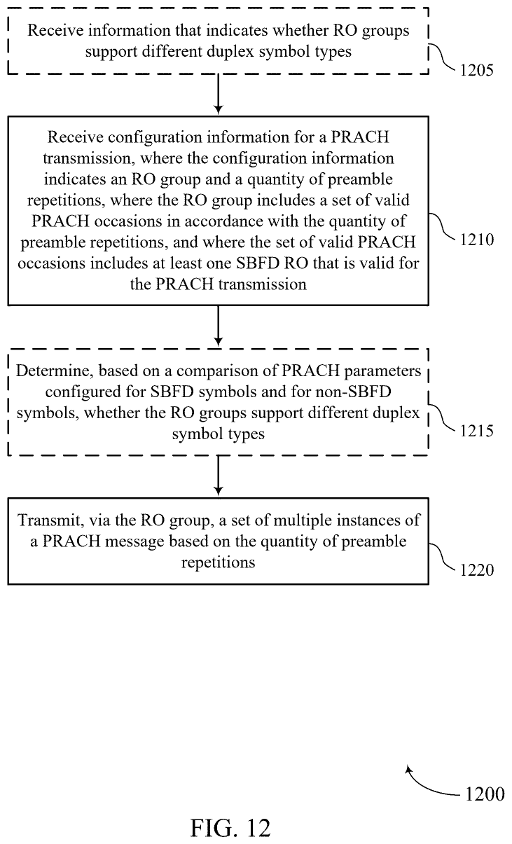

FIG. 12 shows a flowchart illustrating a method 1200 that supports RACH preamble repetition for SBFD operation in accordance with one or more aspects of the present disclosure. The operations of the method 1200 may be implemented by a network entity (e.g., a UE) or its components as described herein. For example, the operations of the method 1200 may be performed by a network entity as described with reference to FIGS. 1 through 10. In some aspects, a network entity may execute a set of instructions to control the functional elements of the network entity to perform the described functions. Additionally, or alternatively, the network entity may perform aspects of the described functions using special-purpose hardware.

In some aspects, at 1205, the method may include receiving information that indicates whether RO groups support different duplex symbol types. The operations of 1205 may be performed in accordance with examples as disclosed herein. In some aspects, aspects of the operations of 1205 may be performed by a duplex symbol support component 935 as described with reference to FIG. 9.

At 1210, the method may include receiving configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The operations of 1210 may be performed in accordance with examples as disclosed herein. In some aspects, aspects of the operations of 1210 may be performed by a RACH configuration component 925 as described with reference to FIG. 9.

In some aspects, at 1215, the method may include determining, based on a comparison of PRACH parameters configured for SBFD symbols and for non-SBFD symbols, whether RO groups support different duplex symbol types. The operations of 1215 may be performed in accordance with examples as disclosed herein. In some aspects, aspects of the operations of 1215 may be performed by a duplex symbol support component 935 as described with reference to FIG. 9.

At 1220, the method may include transmitting, via the RO group, a set of multiple instances of a PRACH message based on the quantity of preamble repetitions. The operations of 1220 may be performed in accordance with examples as disclosed herein. In some aspects, aspects of the operations of 1220 may be performed by a PRACH communication component 930 as described with reference to FIG. 9.

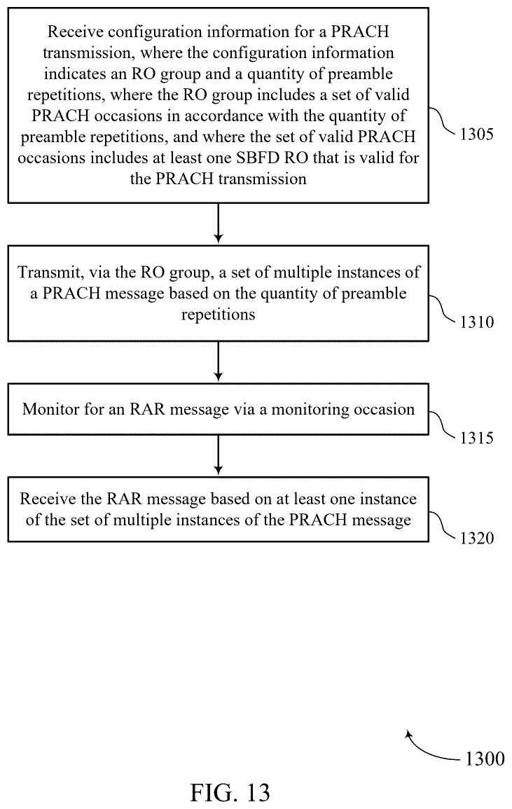

FIG. 13 shows a flowchart illustrating a method 1300 that supports RACH preamble repetition for SBFD operation in accordance with one or more aspects of the present disclosure. The operations of the method 1300 may be implemented by a network entity (e.g., a UE) or its components as described herein. For example, the operations of the method 1300 may be performed by a network entity as described with reference to FIGS. 1 through 10. In some aspects, a network entity may execute a set of instructions to control the functional elements of the network entity to perform the described functions. Additionally, or alternatively, the network entity may perform aspects of the described functions using special-purpose hardware.

At 1305, the method may include receiving configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The operations of 1305 may be performed in accordance with examples as disclosed herein. In some aspects, aspects of the operations of 1305 may be performed by a RACH configuration component 925 as described with reference to FIG. 9.

At 1310, the method may include transmitting, via the RO group, a set of multiple instances of a PRACH message based on the quantity of preamble repetitions. The operations of 1310 may be performed in accordance with examples as disclosed herein. In some aspects, aspects of the operations of 1310 may be performed by a PRACH communication component 930 as described with reference to FIG. 9.

At 1315, the method may include monitoring for an RAR message via a monitoring occasion associated with a single RAR for the set of multiple instances of the PRACH message. The operations of 1315 may be performed in accordance with examples as disclosed herein. In some aspects, aspects of the operations of 1315 may be performed by an RAR component 940 as described with reference to FIG. 9.

At 1320, the method may include receiving the RAR message based on at least one instance of the set of multiple instances of the PRACH message. The operations of 1320 may be performed in accordance with examples as disclosed herein. In some aspects, aspects of the operations of 1320 may be performed by an RAR component 940 as described with reference to FIG. 9.

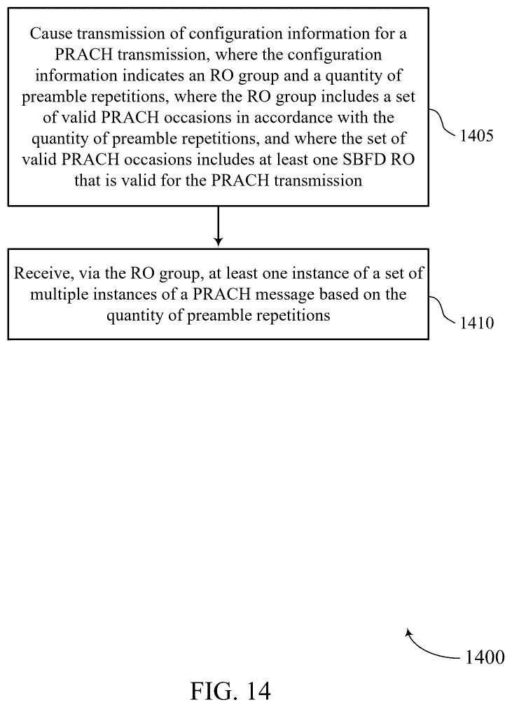

FIG. 14 shows a flowchart illustrating a method 1400 that supports RACH preamble repetition for SBFD operation in accordance with one or more aspects of the present disclosure. The operations of the method 1400 may be implemented by a network entity (e.g., a base station or other network node) or its components as described herein. For example, the operations of the method 1400 may be performed by a network entity as described with reference to FIGS. 1 through 10. In some aspects, a network entity may execute a set of instructions to control the functional elements of the network entity to perform the described functions. Additionally, or alternatively, the network entity may perform aspects of the described functions using special-purpose hardware.

At 1405, the method may include causing transmission of configuration information for a PRACH transmission, where the configuration information indicates an RO group and a quantity of preamble repetitions, where the RO group includes a set of valid PRACH occasions in accordance with the quantity of preamble repetitions, and where the set of valid PRACH occasions includes at least one SBFD RO that is valid for the PRACH transmission. The set of valid PRACH occasions may be in accordance with the quantity of preamble repetitions based on the set of valid PRACH occasions including a quantity of PRACH occasions equal to the quantity of preamble repetitions. The operations of 1405 may be performed in accordance with examples as disclosed herein. In some aspects, aspects of the operations of 1405 may be performed by a RACH configuration component 925 as described with reference to FIG. 9.

At 1410, the method may include receiving, via the RO group, at least one instance of a set of multiple instances of a PRACH message based on the quantity of preamble repetitions. The operations of 1410 may be performed in accordance with examples as disclosed herein. In some aspects, aspects of the operations of 1410 may be performed by a PRACH communication component 930 as described with reference to FIG. 9.

The following provides an overview of aspects of the present disclosure:

Aspect 1: A method for wireless communication performed by a network entity, comprising: receiving configuration information for a PRACH transmission, wherein the configuration information indicates an RO group and a quantity of preamble repetitions, wherein the RO group comprises a set of valid PRACH occasions in accordance with the quantity of preamble repetitions, and wherein the set of valid PRACH occasions comprises at least one SBFD RO that is valid for the PRACH transmission; and transmitting, via the RO group, a plurality of instances of a PRACH message based on the quantity of preamble repetitions.

Aspect 2: The method of aspect 1, wherein the RO group is a first RO group, wherein the first RO group comprises SBFD ROs; and the configuration information further indicates a second RO group, wherein the second RO group comprises TDD ROs.

Aspect 3: The method of aspect 2, wherein the configuration information separately indicates: a first PRACH sequence format, a first transmit beam, a first set of frequency resources, a first RACH preamble, or any combination thereof that correspond to the first RO group, and a second PRACH sequence format different from the first PRACH sequence format, a second transmit beam different from the first transmit beam, a second set of frequency resources different from the first set of frequency resources, a second RACH preamble different from the first RACH preamble, or any combination thereof that correspond to the second RO group.

Aspect 4: The method of either of aspects 2 or 3, wherein the quantity of preamble repetitions is a first quantity of preamble repetitions for the SBFD ROs; and the configuration information separately indicates a second quantity of preamble repetitions for the TDD ROs.

Aspect 5: The method of aspect 2, wherein the configuration information indicates, for the first RO group and the second RO group, a same PRACH sequence format, a same transmit beam, a same set of frequency resources, a same RACH preamble, or any combination thereof.

Aspect 6: The method of either of aspects 2 or 5, wherein the quantity of preamble repetitions corresponds to both the first RO group and the second RO group.

Aspect 7: The method of aspect 1, wherein the RO group comprises the at least one SBFD RO and at least one TDD RO.

Aspect 8: The method of any of aspects 1 through 6, further comprising: receiving information that indicates the RO group supports a same duplex symbol type.

Aspect 9: The method of either of aspects 1 or 7, further comprising: receiving information that indicates the RO group supports different duplex symbol types.

Aspect 10: The method of any of aspects 1 through 7, further comprising: determining, based on a comparison of PRACH parameters configured for SBFD symbols and for non-SBFD symbols, that the RO group supports a same duplex symbol type or different duplex symbol types.

Aspect 11: The method of aspect 10, wherein the PRACH parameters comprise a PRACH sequence format, a transmit beam, a set of frequency resources, a RACH preamble, or any combination thereof.

Aspect 12: The method of any of aspects 1 through 11, wherein the quantity of preamble repetitions is a first quantity of preamble repetitions for the network entity that supports the at least one SBFD RO as valid for the PRACH transmission; and the configuration information further indicates a second quantity of preamble repetitions for a second network entity that fails to recognize SBFD ROs as valid for the PRACH transmission.

Aspect 13: The method of aspect 12, wherein the RO group for the network entity shares one or more ROs with a second RO group for the second network entity; and the RO group and the second RO group correspond to different RACH preambles for the one or more shared ROs.

Aspect 14: The method of aspect 12, wherein first respective ROs of the RO group for the network entity are distinct from second respective ROs of a second RO group for the second network entity.

Aspect 15: The method of any of aspects 1 through 14, further comprising: receiving an RAR message based on at least one instance of the plurality of instances of the PRACH message.

Aspect 16: The method of aspect 15, wherein the plurality of instances of the PRACH message corresponds to a single RAR, the method further comprising: monitoring for the RAR message via a monitoring occasion associated with the single RAR.

Aspect 17: The method of any of aspects 1 through 16, wherein the at least one SBFD RO is within a subband configured for uplink transmission within an SBFD symbol.

Aspect 18: The method of any of aspects 1 through 17, wherein the set of valid PRACH occasions comprises a plurality of PRACH occasions that span a same set of frequency resources, correspond to a same transmit beam, correspond to a same transmit power, correspond to a same RACH preamble, or correspond to a same duplex symbol type.

Aspect 19: The method of any of aspects 1 through 18, wherein the configuration information comprises an RRC signal or a SIB.

Aspect 20: The method of any of aspects 1 through 19, wherein a quantity of the plurality of instances of the PRACH message is equal to the quantity of preamble repetitions.

Aspect 21: The method of any of aspects 1 through 20, wherein the quantity of preamble repetitions is greater than one.

Aspect 22: The method of any of aspects 1 through 21, wherein a quantity of occasions of the set of valid PRACH occasions is equal to the quantity of preamble repetitions.

Aspect 23: A network entity for wireless communication, comprising: a processing system configured to perform a method of any of aspects 1 through 22.

Aspect 24: A network entity for wireless communication, comprising at least one means for performing a method of any of aspects 1 through 22.

Aspect 25: A non-transitory computer-readable medium having code for wireless communication stored thereon that, when executed by a network entity, causes the network entity to perform a method of any of aspects 1 through 22.

Aspect 26: A method for wireless communication performed by a network entity, comprising: causing transmission of configuration information for a PRACH transmission, wherein the configuration information indicates an RO group and a quantity of preamble repetitions, wherein the RO group comprises a set of valid PRACH occasions in accordance with the quantity of preamble repetitions, and wherein the set of valid PRACH occasions comprises at least one SBFD RO that is valid for the PRACH transmission; and receiving, via the RO group, at least one instance of a plurality of instances of a PRACH message based on the quantity of preamble repetitions.

Aspect 27: The method of aspect 26, wherein: the RO group is a first RO group, wherein the first RO group comprises SBFD ROs; and the configuration information further indicates a second RO group, wherein the second RO group comprises TDD ROs.

Aspect 28: The method of aspect 27, wherein the configuration information separately indicates: a first PRACH sequence format, a first transmit beam, a first set of frequency resources, a first RACH preamble, or any combination thereof that correspond to the first RO group, and a second PRACH sequence format different from the first PRACH sequence format, a second transmit beam different from the first transmit beam, a second set of frequency resources different from the first set of frequency resources, a second RACH preamble different from the first RACH preamble, or any combination thereof that correspond to the second RO group.

Aspect 29: The method of either of aspects 27 or 28, wherein the quantity of preamble repetitions is a first quantity of preamble repetitions for the SBFD ROs; and the configuration information separately indicates a second quantity of preamble repetitions for the TDD ROs.

Aspect 30: The method of aspect 27, wherein the configuration information indicates, for the first RO group and the second RO group, a same PRACH sequence format, a same transmit beam, a same set of frequency resources, a same RACH preamble, or any combination thereof.

Aspect 31: The method of either of aspects 27 or 30, wherein the quantity of preamble repetitions corresponds to both the first RO group and the second RO group.

Aspect 32: The method of any of aspects 26 through 31, wherein the configuration information comprises an RRC signal or a SIB.

Aspect 33: A network entity for wireless communication, comprising: a processing system configured to perform a method of any of aspects 26 through 32.

Aspect 34: A network entity for wireless communication, comprising at least one means for performing a method of any of aspects 26 through 32.

Aspect 35: A non-transitory computer-readable medium having code for wireless communication stored thereon that, when executed by a network entity, causes the network entity to perform a method of any of aspects 26 through 32.

The methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Additionally, a “set” refers to one or more items unless specifically disclosed differently (e.g., a set of a plurality of items), and a “subset” refers to a non-empty portion that is less than a whole set unless specifically disclosed to the differently (e.g., a subset of zero or more items of the set one or more items).

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
a processing system configured to:
receive configuration information for a physical random access channel transmission, wherein the configuration information indicates a random access channel occasion group and a quantity of preamble repetitions, wherein the random access channel occasion group comprises a set of valid physical random access channel occasions in accordance with the quantity of preamble repetitions, and wherein the set of valid physical random access channel occasions comprises at least one subband non-overlapping full duplex (SBFD) random access channel occasion that is valid for the physical random access channel transmission; and
transmit, via the random access channel occasion group, a plurality of instances of a physical random access channel message based on the quantity of preamble repetitions.

2. The network entity of claim 1, wherein:
the random access channel occasion group is a first random access channel occasion group, wherein the first random access channel occasion group comprises SBFD random access channel occasions; and
the configuration information further indicates a second random access channel occasion group, wherein the second random access channel occasion group comprises time division duplex (TDD) random access channel occasions.

3. The network entity of claim 2, wherein the configuration information separately indicates:
a first physical random access channel sequence format, a first transmit beam, a first set of frequency resources, a first random access channel preamble, or any combination thereof that correspond to the first random access channel occasion group, and
a second physical random access channel sequence format different from the first physical random access channel sequence format, a second transmit beam different from the first transmit beam, a second set of frequency resources different from the first set of frequency resources, a second random access channel preamble different from the first random access channel preamble, or any combination thereof that correspond to the second random access channel occasion group.

4. The network entity of claim 2, wherein:
the quantity of preamble repetitions is a first quantity of preamble repetitions for the SBFD random access channel occasions; and
the configuration information separately indicates a second quantity of preamble repetitions for the TDD random access channel occasions.

5. The network entity of claim 2, wherein the configuration information indicates, for the first random access channel occasion group and the second random access channel occasion group, a same physical random access channel sequence format, a same transmit beam, a same set of frequency resources, a same random access channel preamble, or any combination thereof.

6. The network entity of claim 2, wherein the quantity of preamble repetitions corresponds to both the first random access channel occasion group and the second random access channel occasion group.

7. The network entity of claim 1, wherein:
the quantity of preamble repetitions is a first quantity of preamble repetitions for the network entity that supports the at least one SBFD random access channel occasion as valid for the physical random access channel transmission; and
the configuration information further indicates a second quantity of preamble repetitions for a second network entity that fails to recognize SBFD random access channel occasions as valid for the physical random access channel transmission.

8. The network entity of claim 7, wherein:
the random access channel occasion group for the network entity shares one or more random access channel occasions with a second random access channel occasion group for the second network entity; and
the random access channel occasion group and the second random access channel occasion group correspond to different random access channel preambles for the one or more shared random access channel occasions.

9. The network entity of claim 7, wherein first respective random access channel occasions of the random access channel occasion group for the network entity are distinct from second respective random access channel occasions of a second random access channel occasion group for the second network entity.

10. The network entity of claim 1, wherein the processing system is configured to:
receive a random access response message based on at least one instance of the plurality of instances of the physical random access channel message.

11. The network entity of claim 10, wherein the plurality of instances of the physical random access channel message corresponds to a single random access response, and the processing system is configured to:
monitor for the random access response message via a monitoring occasion associated with the single random access response.

12. The network entity of claim 1, wherein the at least one SBFD random access channel occasion is within a subband configured for uplink transmission within an SBFD symbol.

13. The network entity of claim 1, wherein the set of valid physical random access channel occasions comprises a plurality of physical random access channel occasions that span a same set of frequency resources, correspond to a same transmit beam, correspond to a same transmit power, correspond to a same random access channel preamble, or correspond to a same duplex symbol type.

14. The network entity of claim 1, wherein the configuration information comprises a radio resource control signal or a system information block.

15. The network entity of claim 1, wherein a quantity of the plurality of instances of the physical random access channel message is equal to the quantity of preamble repetitions.

16. The network entity of claim 1, wherein the quantity of preamble repetitions is greater than one.

17. The network entity of claim 1, wherein a quantity of occasions of the set of valid physical random access channel occasions is equal to the quantity of preamble repetitions.

18. A network entity for wireless communication, comprising:
a processing system configured to:
cause transmission of configuration information for a physical random access channel transmission, wherein the configuration information indicates a random access channel occasion group and a quantity of preamble repetitions, wherein the random access channel occasion group comprises a set of valid physical random access channel occasions in accordance with the quantity of preamble repetitions, and wherein the set of valid physical random access channel occasions comprises at least one subband non-overlapping full duplex (SBFD) random access channel occasion that is valid for the physical random access channel transmission; and
receive, via the random access channel occasion group, at least one instance of a plurality of instances of a physical random access channel message based on the quantity of preamble repetitions.

19. The network entity of claim 18, wherein:
the random access channel occasion group is a first random access channel occasion group, wherein the first random access channel occasion group comprises SBFD random access channel occasions; and
the configuration information further indicates a second random access channel occasion group, wherein the second random access channel occasion group comprises time division duplex (TDD) random access channel occasions.

20. The network entity of claim 19, wherein the configuration information separately indicates:
a first physical random access channel sequence format, a first transmit beam, a first set of frequency resources, a first random access channel preamble, or any combination thereof that correspond to the first random access channel occasion group, and
a second physical random access channel sequence format different from the first physical random access channel sequence format, a second transmit beam different from the first transmit beam, a second set of frequency resources different from the first set of frequency resources, a second random access channel preamble different from the first random access channel preamble, or any combination thereof that correspond to the second random access channel occasion group.
